(19) United States
(12) Patent Application Publication
(10) Pub. No.: US 2009/0271326 A1
(43) Pub. Date: Oct. 29, 2009

(54) RETIREMENT FUND AND METHOD FOR GENERATING INCREASE REVENUE STREAM

(76) Inventors: Dale B. Finfrock, Palm Beach, FL (US); A. Rene Dervaes, JR., Yulee, FL (US); Robert S. Dervaes, Glen Allen, VA (US)

Correspondence Address: MALIN HALEY DIMAGGIO BOWEN & LHOTA, P.A., 1936 S ANDREWS AVENUE, FORT LAUDERDALE, FL, 33316, US

(21) Appl. No.: 12/108,131

(22) Filed: Apr. 23, 2008

(51) Int. Cl. G06Q 40/00

(52) U.S. Cl. 705/36 R

(57) ABSTRACT

A retirement fund and method for operating to produce an ever increasing revenue stream to a group of investor participants who are selected statistically based on the longevity into a pool of investors. An investment partnership is created with the selected investor participants. A financial portfolio is created from monies from each investor. The money is used to purchase high quality securities that generate income for the investment partnership. As each year of the investment partnership passes, the surviving members of the investment partnership are entitled to receive the revenue generated from the portfolio which statistically will increase yearly for the living members that survive. The investment partnership can purchase term life insurance on each investor participant used to pay back the initial investor participant who becomes deceased during the term of the investment partnership so that each investor or his estate receives his initial investment back. Upon termination at the end of a fixed period of the investment partnership, any remaining assets will be distributed pro rata among the living remaining members of the investment partnership.

### BACKGROUND OF THE INVENTION

1. Field of the Invention

This invention relates to a retirement fund in the field of financial securities to generate a stream of income for a pool of seniors as they grow older and, in particular, to a retirement fund and method for providing an increasing stream of annual revenue to the survivors in the pool as the investors grow older.

2. Description of Related Art

The United States is experiencing a demographic increase in people reaching the customary retirement age of 65 years old. The group has been named “Baby Boomers.” A chief concern of each senior citizen is to maintain a stream of retirement income until death. For this reason a number of financial programs are now available specifically directed to senior citizens for the purpose of providing steady income during retirement. Steady income throughout retirement years helps prevent retired individuals from becoming financial burdens upon their children should they outlive their assets. However, if retirees rely upon fixed incomes, the possibility exists that inflation will depreciate the fixed incomes to a level that may quickly consume their net worth. In an effort to forego such a possibility, numerous programs have been developed to insure the retirees' continued incomes.

Conventional passbook saving accounts, certificate of deposits, or bond purchases maintained by an individual provide a predictable flow of income but do not provide a procedure for maintaining pace with inflation. Similarly, numerous annuity offerings are made available providing the recipient the right to receive fixed periodic payments either for life or for a term of years. Annuities include bonds, trust contingent, deferred group, joint, life, private, refund, retirement, straight, and variable to name a few. The payments represent a partial return of capital and return of interest.

Insurance is a program generally made operative by death providing the beneficiary with proceeds at death. For a couple in retirement, a spouse typically collects the insurance proceeds upon the death of the spouse. Insurance can also be used to provide protection for uncertain costs. U.S. Pat. Nos. 4,642,768, 4,722,055 and 4,752,877 issued to Roberts discloses a method and apparatus for funding future liability of uncertain costs. The program allows the investor to fund a fairly certain future cost such as a child's college education as well as estimate the expected cost of the liability, when the liability will incur, and the amount of insurance necessary to cover the liability.

What cannot be predicted is how long an individual will live. Therefore, what is needed is a process and system for providing a retired investor with a predictable income as well as a device for providing the individual with a statistical method of increasing that income during the remaining lifetime of the individual.

### SUMMARY OF THE INVENTION

A retirement fund and method for providing an increasing stream of revenue for individual investors as each investor grows older. The retirement program is based upon individuals in a pool of investors. In a preferred embodiment, the retirement fund is based upon a pool of investors having very similar longevity statistics. To insure that investor participants in a particular pool have at least a reasonable approximation of the estimated longevity, no pool is formed with fewer than one hundred participants, although a pool could be established with any number of participants. The investor pool of individuals will be selected by age, year of birth and gender to establish a group of investors of very similar longevity statistics.

The retirement fund is established by selecting a pool of investors of the same statistical longevity. Each participant investor pays a fixed investment to an investment partnership. The investment partnership is established for a fixed predetermined period of time such as twenty-five years. For example, if the pool is made up of 60 year old men and the total investment period is twenty-five years, the program will be set up until the investor participants reach the age of 85 years old.

The investment partnership establishes an investment portfolio. The funds invested by each participant in the statistical pool are used to invest in high quality debt securities that may or may not include United States Government Treasuries.

The initial investor fund forming the portfolio and the investment partnership will be used to invest in United States Government Treasuries or other high quality debt securities which will be posted as collateral to invest in futures contracts that mimic the performance of the Standard and Poors Diversified Trends Indicator (“S&P DTI”). The future contracts will then provide the dividend income for payment back to the investor participants typically on an annual basis for those investor participants that are alive when the dividends are paid.

The investment partnership acquires term life insurance for each of the investor participants in the amount of the face value of the original investor participant's funding. Thus, if each investor participant pays, for example, $250,000.00 into the investment partnership, the term life insurance policy on that particular individual investor will be in the face value amount of $250,000.00. The owner of the policy is the insured investor participant. Premium payments on the term insurance policy of each initial investor are paid by the investment partnership.

The dividends or return of monies on the portfolio is distributed pro rata to all current living investor participants in the investment partnership per annum. In the event of a death of one of the investor participants, the term life insurance will mature and the investor participant's interest in the investment partnership will terminate. Thus, each initial investor participant or that person's estate will receive back the initial investment paid at the beginning of the retirement fund. Thus, the heirs will get the benefit of the initial investment return of each deceased participant.

The investment partnership is initially set up for a fixed period of years. When the investment partnership reaches the end of the fixed time period, such as twenty-five or thirty years, the investment partnership will be terminated. The remaining assets of the investment partnership will be liquidated and distributed on a pro rata basis to the remaining living investor participants upon termination.

In an alternate embodiment, if an investor participant should die before the termination of the investment partnership, in lieu of term life insurance being paid on each investor participant, the specific participant's investment initially made by the investor participant shall be returned to the heirs or the estate or an assignee of the original investor at the time the investment partnership is terminated at the end of the fixed period of years. In this particular embodiment, thus, the original participant investment shall be returned to the investor participant, if alive, or the participant's estate or heirs if the participant is not living at the end of the investment partnership.

In another alternate embodiment, a particular participant investor, while alive, upon reaching certain unusual dire financial circumstances, could request from the investment partnership to withdraw and the investor will be given the investor's initial investment back with some type of penalty paid to the investment partnership for tracking or withdrawing the participant's original investment.

The retirement fund and method provided herein for generating a stream of income for retirees who survive thus includes the ability for either sharing the final amount of money at the end of a fixed term such as twenty-five years by all living participants while each of the deceased initial investors' estates receive their monies back through term life insurance benefits upon death or return of the share at the end of the twenty-five year period to the estate of the deceased participant.

Participant investors who survive their fellow participants have the potential for sharing in an increased share of the portfolio's interest and increasing annual revenue stream. In the event all participant investors in a particular investment partnership pool should die before termination period of the investment partnership, the net proceeds are distributed to the estate, heirs or assignees of the original investors. The investment of unit holders principal is not affected by death, for upon liquidation of the fund, each investor or his estate or designate is expected to receive an amount more or less equal to his or her original investment.

U.S. Government Treasuries provide an extremely secure investment because they are insured by the U.S. Government. In one program, the primary high quality security that will be invested in the portfolio by the investment partnership could be in U.S. Government Treasuries.

Accordingly, the program's principal purpose is to provide a source of income to meet the increasing expenses of those investor participants who live extended lives. This objective will be met by terminating the right of any investor who dies in the interim provided by the investment portfolio, thereby increasing the amount of funds available for distribution to surviving investors.

Interest revenue from the investment partnership portfolio is allocated pro rata periodically to the living pool of investor participants who make up the investment partnership. Annual dividends or lesser period, such as quarterly dividends, can be paid to the living participants. Upon death of an investor participant, that person is terminated from the investment partnership.

Since only those participants who are living will be entitled to participate in dividends, the interest allocated to each investor participant will be divided among a smaller and smaller number of participants (statistically) as time goes on, and the revenue stream annually payable to surviving participants may be expected to increase.

In the event all investor participants in a pool who have invested the same amount have died before the termination period of the investment partnership, the portfolio assets will be sold and all proceeds distributed to the investment partnership participant's estates, heirs and assignees pro rata.

The portfolio that is maintained by the investment partnership as referenced above is essentially invested in high quality securities. In one embodiment, the investment partnership could post a portion of each purchase of U.S. Government Treasuries as collateral and then purchase future contracts that mimic performance of the S&P DTI. These assets collectively make up the “portfolio,” However, it is certainly within the scope of this invention that there can be a number of broad based underlying assets for the investment portfolio that could include bonds, stocks, options, funds including mutual funds, tracker, ETFs, notes, mortgages, REITS, real estate or even commodities. The underlying assets could also include taxable and tax-free municipal bonds or similar instruments.

In view of the foregoing, it is an objective of the retirement fund to provide a method for generating increased revenue to participants from the interest gained from pooled high quality securities to the remaining living fund participants.

Another objective of the retirement fund is to provide a method for administering a program to senior citizens utilizing income producing high quality securities, jointly pooled and singularly administered.

Another objective of the retirement fund is to provide an investment program providing increased annual income whose benefit is derived upon living, the income derived therefrom depending upon the participant's longevity in respect to co-participants during the interest bearing years of high quality securities.

In accordance with these and other objects which will become apparent hereinafter, the instant invention will now be described with particular reference to the accompanying drawings.

### BRIEF DESCRIPTION OF THE DRAWINGS

FIG. 1 is a block diagram showing the organizational elements of the retirement fund.

FIG. 2 is a flow chart showing the method used to operate the retirement find.

FIG. 3 is a flow chart of an alternate embodiment of the retirement find and method.

### DETAILED DESCRIPTION OF THE INVENTION

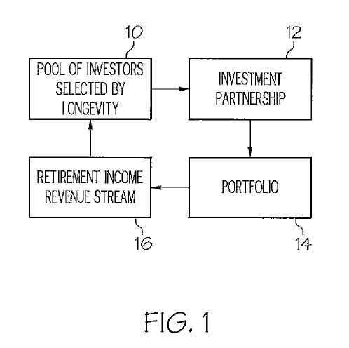

Referring now to the drawings and, in particular, FIG. 1, the retirement fund is organized in accordance with FIG. 1 to include the starting point of selecting a pool of investors by statistics that evidence longevity. The pool of investor participants should be people that demographically have very similar statistical estimates of longevity. For example, men statistically have a different longevity than women. Therefore, one pool of investors would be selected for men, particularly born in the same year group, and a different pool of investors could be made tip of women also born in the same year group for statistical longevity purposes. For example, a pool could be made up of at least a minimum of one hundred men, each sixty years of age based on certain birth dates when the pool is established. Likewise, the pool could be made up of at least one hundred women each being sixty years of age and born in the same year. In the selection of investors, longevity is very important to the statistical play out of the entire investment partnership, which would be established for a fixed number of years such as twenty-five or thirty years. However, a pool could easily be made up of both women and men using women of different ages than the men because of the statistical difference in the longevity of women over men. However, the pool could include a group of women of a particular age that is statistically equal in longevity to likewise additional men in the pool that would have a lower age but also based on the same statistical longevity as the age group of the women selected in the same pool. Therefore, the pool does not have to be to one particular gender. As shown in FIG. 1, the pool of investors, once selected, are then used to form an investment partnership 12. The investment partnership 12 would include a fixed payment or initial investment by each investor that has been selected into the pool. For example, one hundred investors could make up the pool and each investor would be responsible for contributing $250,000.00 initial investment into the investment partnership. That would establish $25,000,000.00 fund for the investment partnership.

The investment partnership 12 then establishes the portfolio 14 using high quality securities based on the initial funding by the investors that form the investment partnership. With the retirement fund model shown in FIG. 1, the revenue or dividends from the high quality securities that establish the portfolio 14 produce a retirement income revenue stream shown at 16 that is paid back to the investors at least annually and may be paid even more often such as quarterly to those investors who remain alive during the investment pay period.

In one embodiment, the portfolio 14 in FIG. 1 can be established through the purchase by the investment partnership of U.S. Government Treasuries with the initial investment of the participants in the investment partnership. The U.S. Government Treasuries are then used as collateral to purchase futures contracts. The futures contracts, preferably in one embodiment, would mimic the performance of the Standard & Poors Diversified Trends Indicator (“S&P DTI”). However, in selection of the particular securities in the portfolio, the portfolio can be quite diverse as is discussed below.

The goal of the retirement fund is to provide security to the investor for life.

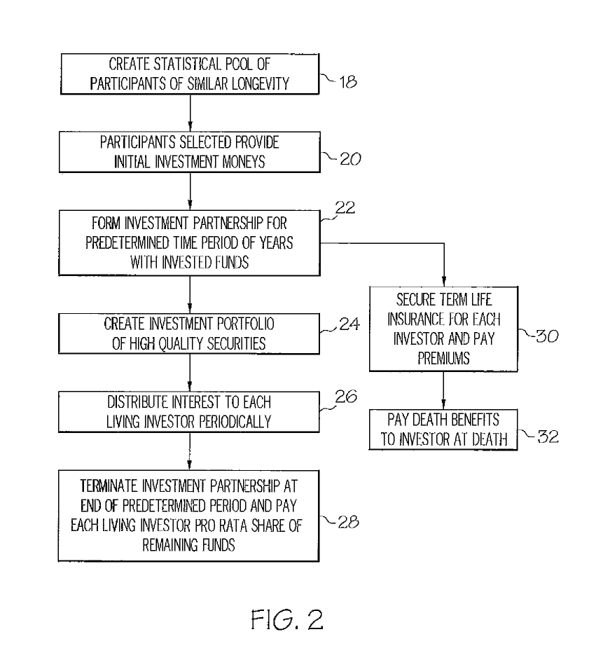

Referring now to FIG. 2, one retirement fund process is shown to establish the revenue stream necessary to fund the retirement of the remaining living participants as time passes.

The first step 18 is to create a pool of participants of similar statistical longevity. The pool of persons should be large enough to statistically provide a realistic spectrum of investment people that will reach different ages. As discussed above, one method of selecting a pool of individuals of similar longevity would be to pick individuals by gender of a specific age group or birth year to establish a pool of participants. The pool of participants as shown in element 18 would then contribute a specific fixed amount of monies for the initial investment monies from each participant as shown in element 20. The participant and the money are then used to form an investment partnership 22 that has typically a fixed time period of years with the invested funds. In one example, the fixed period of years could be for twenty-five years. So, if the statistical pool is comprised of individuals or participants that are sixty year old males and the investment partnership is for twenty-five years, then the life span of people participating in the investment partnership could be from the year sixty years old to eighty-five years old. As an example, a pool of 100 investors would invest $250,000.00 each into the investment partnership for a term of twenty-five years.

These funds shown in element 24 would be used to create the investment portfolio and could be invested in the United States Government Treasuries or other high quality debt securities. The high quality debt securities would be posted as collateral to invest in future contracts that in the Preferred Embodiment mimic the performance of the Standard & Poors Diversified Trends Indicator. This relates to element 24 in FIG. 2.

The investment partnership acquires term life insurance for each of the investors as shown in element 30 in the amount of the original investment from each participant. The owner and estate of the term life insurance policy would be the insured, who is an investor participant in the investment partnership, or an irrevocable life insurance trust set up by the insured. The premium payments for the term life insurance will be paid by the investment partnership on behalf of each investor participant.

As shown in element 26, the portfolio revenues will be used to distribute interest or return on the portfolio pro rata to all the current investors in the fund that are living. Typically, the distribution would be at least annually and preferably quarterly to each of the investor participants that are alive.

As shown at element 32 in FIG. 2, in the event of a death of an investor participant, the respective term insurance will mature and the investor participant's interest in the investment partnership will terminate. Note that the estate of the deceased investor participant will receive an amount from the term life insurance that is approximately equal to the investor participant's initial, original investment.

As shown in element 28 in FIG. 2, at the termination of the investment partnership at the end of the fixed period of time such as twenty-five years, all the assets that remain in the investment partnership would be liquidated and distributed on a pro rata basis to the remaining living investor participants.

It should be noted that statistically as the investment partnership years pass, there will be statistically fewer and fewer remaining investor participants based on statistical rates of longevity such that the living remaining investor participants will be entitled to receive increasing amounts of annual revenue from the portfolio due to the reduced numbers of people that are participating. The result is that the longer someone lives, who participates in this retirement fund, statistically on each year of life, the participant's revenue stream should increase. This retirement fund, thus, can greatly increase the revenue stream based on living longer which is of great concern to all retired people so that they do not out live their financial resources or are not reduced in income based on inflation. Thus, the retirement fund and method described herein is a highly secure investment based on those who live the longest so that they do not run out of money.

The retirement fund is capable of providing similar but different embodiments of the overall retirement fund in operation for retired persons and generating the revenue stream.

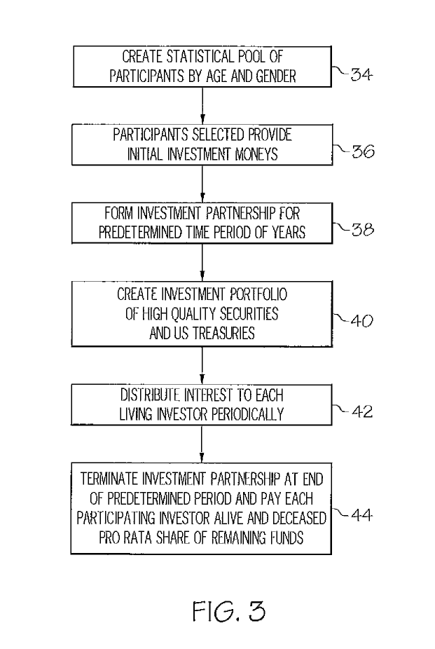

Referring now to FIG. 3, an alternate embodiment of the retirement fund shown in FIG. 2 is provided. As in the previous retirement fund, a pool of statistical participants is created based on longevity as shown in element 34 of FIG. 3 by age and gender. Since women have a statistical longer life span than men, a pool is selected of men only or women only and by a particular age group such as a year of birth. At least one hundred participants will be necessary to establish a statistical pool. However, as pointed out above, the pool could be made up of both genders, men and women, and their particular selection in the pool would be based on the fact that the ages of the men and the women selected would be such that the pool would have a statistical longevity that is the same for all of the participants, both men and women. Therefore, the pool does not have to be one gender only.

Again, as shown in element 36, the selected participants are then created into an investment partnership and are required to individually fund the investment partnership by providing a fixed amount of money to the investment partnership.

The investment partnership that is formed element 38 in FIG. 3 is established for a fixed time period such as twenty-five or thirty years which is typically based on the age of the pool of participants and their anticipated longevity.

The investment partnership will then create a portfolio of high quality securities which may or may not include U.S. Treasuries to generate revenue in the portfolio for the retirement income of the living participants.

In the embodiment shown in FIG. 3, the investment partnership does not purchase term life insurance for each of the investors.

As the investment partnership proceeds from year to year and investor participants become deceased, the deceased investor participant and his or her estate do not continue to receive annual revenues from the portfolio. However, the portfolio does distribute, as shown in element 42, revenue or interest to each living investor participant periodically such as annually or preferable quarterly each year of the investment partnership.

Note, however, when the investment partnership time expires for the fixed period such as twenty-five years, the investment partnership will be terminated. Each of the original investor participants, if alive or if deceased, their estate will receive the pro rata share of the investment money left in the investment partnership to both alive and deceased investor participants. Thus, everyone in the initial pool that started in the investment partnership or that person's estate or assignees would then receive back the initial investment and any additional revenues generated by the portfolio at the time it is terminated.

One of the important features of the retirement fund is the creation of a portfolio which in the Preferred Embodiment is set up with future contracts that best mimic the performance of Standard & Poors Dividend Trends Indicator.

The portfolio maintained by the investment partnership can be comprised of numerous different types of financial instruments to generate revenue for payment of a revenue stream to the investor participants annually. Thus, the investment portfolio could include mutual funds, bonds, stocks, options, tracker, EFTs, notes, mortgages, REITS, real estate, commodities, Treasuries or other types of similar investments now available or conceived in the future. The underlying assets could also include taxable and tax free municipal bonds or similar instruments. In addition to the numerous different types of financial instruments that are available for use in the portfolio to generate revenue for payment of a revenue stream to the investor participants that are typically selected in the United States, foreign financial instruments may also be utilized. For example, the British Government has a financial instrument termed “Commonwealth Shares.” This foreign instrument could be used in the portfolio for generating revenue over the fixed time period. Other quality foreign financial instruments may also be used. It would be up to the managers of the investment partnership to select specifically the high quality debt securities or whatever financial instruments are placed inside the portfolio to generate revenue over the fixed time period of the investment partnership for payment back to the investor participants.

The retirement fund described herein and the method of providing it clearly establishes a financial fund that can greatly benefit those fortunate individuals that survive beyond the statistical norm and ensure that the person will not run out of money even as octogenarians survive into their nineties because the revenue stream from the retirement fund would be increasing yearly as some of the participants become deceased.

The instant invention that has been shown and described herein is considered to be the most practical and preferred embodiment. It is recognized, however, that departures may be made therefrom within the scope of the invention and that obvious modifications will occur to a person skilled in the art.

What is claimed is:

1. A retirement fund for increasing the revenue stream to participating investors as they grow older comprising:
a pool of investor participants selected based on statistical longevity so that the pool of investor participants have similar statistical longevity;
an investment partnership fund that includes all of the participating investors that have been pre-selected based on statistical longevity;
a portfolio that is funded by contributions of a fixed amount of money from each participating investor that is member of the investment partnership;
a plurality of high quality securities purchased with the funds from participating investors in the portfolio;
an ongoing payment plan that pays participating investors that are alive at the time of payment revenue gained from the portfolio, said payments made on at least on an annual basis to each of the living participating investors;
a plurality of term life insurance policies purchased by the investment partnership for each of the participating investors with the beneficiary being a participating investor; and
said investment partnership established for a fixed number of years and including a termination date, whereupon when the investment partnership reaches the termination date, each of the participating investors alive at the investment partnership termination date will be provided with approximately a pro rata share of the remaining assets of the investment partnership.

2. The method of providing a retirement fund for participating investors to protect against inflation and to increase annual revenue or retirement finding to the participating investors comprising the steps of:
establishing a pool of investors based on statistical longevity such that the pool of investors have similar statistical longevity;
creating an investment partnership of the selected pool members of participating investors;
each of said participating investors in said investment partnership contributing a fixed sum of money to a fund to establish a portfolio;
purchasing high quality securities with the fixed amount of monies invested by said participating investors in said portfolio;
using the high quality securities in said portfolio as collateral to obtain futures contracts that mimic the Standard & Poors DTI to produce an annual revenue stream from said portfolio;
providing to each participating investor in said investment partnership alive a pro rata share of the investment proceeds from said portfolio on an annual basis;
said investment partnership purchasing term life insurance for each participating investor in said investment partnership in the amount to approximate the fixed monetary investment of each participating investor, said investment partnership paying the premiums of each of the term life insurance policies of the participating investors and paying death benefits upon the death of any of the participating investors in the investment partnership; and
upon the termination of the investment partnership, payment to each of the surviving participating investors of the residual assets in the portfolio on a pro rata basis.

3. A method as in claim 2, including the step of:
selecting a pool of participating investors statistically based on gender and age and establishing a fixed period of years for the investment partnership until termination.

4. A method as in claim 2, comprising the steps of:
purchasing U.S. Government Treasuries initially with the fixed funding payments made by participating investors and setting up the portfolio.

5. A method as in claim 2, including the steps of:
said portfolio investing a portion of its funds in other investments that include real estate, foreign currency, bonds or other high quality investments to produce a revenue stream from said portfolio that is paid to the surviving participating investors on an annual basis.

6. A retirement fund comprising:
a pool of participating investors selected statistically such that the pool members have very similar statistics of longevity;
an investment partnership formed of said participating investors;
a fund established by all of said participating investors contributing a fixed amount of money to the fund;
a portfolio of high quality securities purchased with said fund from said participating investors, said high quality securities producing an annual revenue stream;
a portfolio made up of said fund, said high quality securities and the revenue stream obtained from said securities;
the payment plan for paying each surviving participating investor annually a pro rata portion of said revenue stream received from said investment of said high quality securities; and
an investment partnership termination plan that fixes the number of years of existence of the investment partnership and upon termination of the investment partnership payment of residual assets in the portfolio to all of the original participating investors whether they are dead or alive.

7. A method of funding a retirement program comprising the steps of:
establishing a pool of participating investors based on a statistical criteria of longevity;
providing a find by receiving investment monies from each of said participating investors in said pool;
investing said fund in high quality securities to produce and generate a revenue stream of income from said fund on an annual basis; and
paying the surviving participating investors on an annual basis a pro rata share of the revenue stream generated by said high quality securities.

8. The method as in claim 7, including the step of:
investing the portfolio in broad based underlying assets that include bonds, stocks, options, funds including mutual funds, mortgages, notes, ETFs, REITS, real estate or commodities, and taxable or tax free municipal bonds. Thus, the investment portfolio could include mutual funds, bonds, stocks, options, tracker, EFTs, notes, mortgages, REITS, real estate, commodities, Treasuries or other types of similar investments now available or conceived in the future, taxable and tax free municipal bonds or similar instruments.
